(19) United States
(12) Patent Application Publication
(10) Pub. No.: US 2009/0034428 A1
(43) Pub. Date: Feb. 5, 2009

(54) METHOD AND SYSTEM FOR PROVIDING QOS FOR MOBILE INTERNET SERVICE

(75) Inventor: Jin Hwa Jeong, Gyeonggi (KR)

Correspondence Address: BLANK ROME LLP, 600 NEW HAMPSHIRE AVENUE, N.W., WASHINGTON, DC, 20037, US

(73) Assignee: POSDATA CO., LTD.

(21) Appl. No.: 12/280,718

(22) PCT Filed: Mar. 15, 2007
(86) PCT No.: PCT/KR2007/001272

§ 371 Date: Aug. 26, 2008

(30) Foreign Application Priority Data
Mar. 16, 2006 (KR) 10-2006-0024417

(51) Int. Cl. H04L 12/26

(52) U.S. Cl. 370/252

(57) ABSTRACT

Disclosed are a QoS (Quality of Service) providing system that manages service quality of a mobile Internet system, and an apparatus and method that apply QoS according to the class of a mobile Internet service provided over a mobile Internet network. The QoS providing system includes a service class table storage unit for storing at least one QoS parameter value for a plurality of mobile Internet services; a service identifying unit for identifying a QoS service class of a mobile Internet service requested over the mobile Internet network; a QoS parameter extracting unit for extracting QoS parameters of the identified mobile Internet service by referring to the service class table; and a QoS performing unit for performing QoS on the requested mobile Internet service according to the extracted QoS parameters. Thus, several types of services can be provided simultaneously and smoothly according to a requested service characteristic in a mobile Internet network in which real-time competition for resources occurs.

### TECHNICAL FIELD

The present invention relates to a QoS (Quality of Service) providing system that manages quality of mobile Internet service. More particularly, the present invention relates to an apparatus and method for performing end-to-end QoS management by applying a QoS policy to various mobile Internet services.

### BACKGROUND ART

The information communication service industry has rapidly grown due to the spread of new services, such as wireless Internet and high-speed Internet based on mobile telephone service. As the market matures, growth of the wireless Internet and high-speed Internet market has begun to slow. At this juncture, mobile Internet service has come into the spotlight as stimulus for a new wave of growth of the Information communication industry.

Mobile Internet service allows users to rapidly access wireless Internet anywhere, anytime with full mobility to enjoy various information and contents using a portable subscriber station (PSS). Mobile Internet service differs from wireless Internet service and high-speed Internet service in that high-speed wireless Internet access is possible.

Wireless Internet service provided by third-generation mobile communication overcomes limitations of second-generation mobile communication which mainly provides voice service and allows digital data to be transmitted and received using a mobile terminal. However, such wireless Internet service is not suitable for multimedia information exchange or high-speed transmission of large amounts of data due to a bandwidth limitation.

Mobile Internet is a service that has the advantages of broadband high-speed Internet in order to overcome this limitation of wireless Internet. It is expected that the mobile Internet can provide various services such as game-on-demand (GOD), video-on-demand (VOD), digital broadcasting, in addition to existing voice or data service by adopting various techniques for high-speed data transmission.

Meanwhile, this expansion of applications is accompanied by considerable traffic increase. Accordingly, mobile Internet service requires a very high bandwidth in comparison with conventional wireless Internet service. However, as applications become more diverse in quality as well as in quantity, simple bandwidth increase alone cannot guarantee excellent service quality.

A technique for ensuring transmission reliability and real-time capability, as well as bandwidth increase, is necessary. This technique is called a QoS (Quality of Service) management technique.

As the high-speed Internet already supports broadband service, various QoS management schemes have been studied and already put into practice. However, since Internet service based on conventional wireless Internet networks, e.g., code division multiple access (CDMA), wideband CDMA (W-CDMA), global system for mobile communication (GSM), operates using lines, QoS application was unnecessary.

That is, in a conventional wireless Internet system, once a call is set up, traffic resources are secured until the call is terminated. Accordingly, the call is not affected by other calls. For example, by CDMA, each sector can simultaneously accommodate up to 20 subscribers, and when a 21^{st} subscriber attempts to make a call, the system is regarded as being ‘BUSY’ and the call is not accepted. Accordingly, even without QoS, subscribers with calls in progress are not affected.

However, for a mobile Internet network, e.g., a WiBro/WiMAX system, several subscribers who are connected simultaneously compete to occupy resources. Accordingly, unlike third-generation wireless Internet service, QoS management, which uses a traffic resource use method determined according to service type, is necessary.

The present invention suggests a new technique of applying QoS management, which is unnecessary in a conventional wireless Internet system, to a mobile Internet network, i.e., an Internet network that is a combination of a wireline network and a wireless network.

### DISCLOSURE OF INVENTION

### Technical Problem

The present invention is directed to a QoS providing system that manages quality of mobile Internet service.

Also, the present invention is directed to classifying mobile Internet services according to service classes and performing QoS management for each service class, thus flexibly processing various service requests from subscribers.

Also, the present invention is directed to performing QoS in a mobile Internet network that is a combination of a wireline network and a wireless network, to enable services to be smoothly provided between a PSS and a wired terminal.

Also, the present invention is directed to dynamically extracting QoS parameters for a service requested by a PSS and comparing them with a pre-stored parameter in a service class table, to adaptively perform QoS according to traffic state.

Also, the present invention is directed to identifying mobile Internet service corresponding to a received IP packet and performing scheduling or QoS field marking according to the identified class of the service, to effectively perform QoS.

Also, the present invention is directed to applying a different scheduling scheme according to a class of mobile Internet service, to improve QoS management performance for mobile Internet service.

Also, the present invention is directed to applying QoS management to mobile Internet services excluding a best effort (BE) service, to effectively support QoS without increasing a system load and thereby improve system performance.

Also, the present invention is directed to implementing QoS management through a system including a radio access station (RAS), an access control router (ACR), a quality manager (QM), an element management system (EMS), and the like, to effectively perform QoS over a network.

Also, the present invention is directed to allowing a quality manager and an ACR to exchange a control signal with each other using known standard protocols such as COPS or Diameter, to facilitate interworking with other systems.

### Technical Solution

One aspect of the present invention provides a QoS providing system comprising: a service class table storage unit for storing at least one QoS parameter value for a plurality of mobile Internet services; a service identifying unit for identifying a QoS service class of a mobile Internet service requested over the mobile Internet network; a QoS parameter extracting unit for extracting a QoS parameter value of the identified mobile Internet service by referring to the service class table; and a QoS performing unit for performing QoS on the requested mobile Internet service according to the extracted QoS parameter value.

Another aspect of the present invention provides a QoS providing method comprising the steps of: creating a service class table storage unit for storing at least one first QoS parameter value for each of a plurality of mobile Internet services; generating a second QoS parameter value in response to a request for mobile Internet service received from a PSS; comparing the first QoS parameter value stored in the service class table storage unit to the second QoS parameter value to identify a QoS service class of the requested mobile Internet service; creating a service flow of the requested mobile Internet service according to the QoS service class; and performing QoS on the requested mobile Internet service for each created service flow.

Still another aspect of the present invention provides a QoS providing system comprising an element management system (EMS) for creating a service class table that stores at least one first QoS parameter value for each of a plurality of mobile Internet services; a quality manager (QM) for generating a second QoS parameter value in response to a request for mobile Internet service received from a PSS; an access control router (ACR) for comparing the first QoS parameter value to the second QoS parameter value to identify a class of the requested mobile Internet service; and a radio access station (RAS) for assigning a wireless channel for the identified mobile Internet service, and communicating IP packets with the PSS via the assigned wireless channel.

Still another aspect of the present invention provides a method for providing QoS service comprising the steps of: receiving a request of a mobile internet service; identifying QoS parameters from the request; creating a service flow identifier to identify a service flow based on the QoS parameters; mapping the service flow identifier to a connection identification identifier to perform the QoS service for the service flow.

### Advantageous Effects

With the QoS providing method and system according to the present invention, QoS management is performed for each service flow on mobile Internet services provided over a mobile Internet network, so that various mobile Internet services are assigned a proper amount of traffic resources, thereby effectively performing QoS on a plurality of mobile Internet services having different requirements.

QoS is performed on a mobile Internet network that is a combination of a wireline network and a wireless network, thereby enabling services to be smoothly provided between a PSS and a wired terminal.

In addition, QoS parameters are dynamically extracted for a service requested by a PSS and compared with pre-stored parameters in a service class table, thus adaptively performing QoS according to traffic state.

The mobile Internet service corresponding to the received IP packet is identified, and scheduling or marking the QoS field is performed according to the identified class of the service, thereby effectively performing QoS.

In particular, the mobile Internet services are classified into several types according to service characteristics, a different priority is assigned to each service type, and a different scheduling scheme is applied to services having the same priority, thus flexibly processing various service requests.

The QoS management may be applied only to mobile Internet services other than a best effort (BE) service, thereby effectively supporting QoS without greatly increasing a system load.

In addition, QoS management is implemented by a system including a radio access station (RAS), an ACR, a quality manager (QM), an element management system (EMS), and the like, thereby effectively performing QoS over a network.

The quality manager and the ACR exchange a control signal with each other using a known standard protocol, thereby facilitating interworking with other systems.

Furthermore, a PSS decides whether a requested service is a best effort service to determine whether to send a QoS service providing request to an AF (Application Function), thereby simplifying the configuration of the QoS providing method and system.

### BRIEF DESCRIPTION OF THE DRAWINGS

FIG. 1 is a block diagram illustrating a QoS providing system according to the present invention;

FIG. 2 is a service class table used for service identification in the QoS providing system according to the present invention;

FIG. 3 is a block diagram illustrating a QoS performing unit of the QoS providing system according to the present invention;

FIG. 4 is a block diagram illustrating a system for QoS management in a mobile Internet network that is a combination of a wireline network and a wireless network according to the present invention;

FIG. 5 is a flow diagram illustrating a procedure of processing calls including a request for mobile Internet service by applying a standard protocol in a QoS providing system according to the present invention;

FIG. 6 is a block diagram illustrating a quality manager (QM) of a QoS providing system according to the present invention;

FIG. 7 is a block diagram illustrating an access control router (ACR) of a QoS providing system according to the present invention;

FIG. 8 is a block diagram illustrating a radio access station (RAS) of a QoS providing system according to the present invention;

FIG. 9 is a flowchart illustrating a method for QoS management according to the present invention; and

FIG. 10 is a block diagram illustrating a QoS providing method performed by a PSS in a QoS providing system according to an exemplary embodiment of the present invention.

### MODE FOR THE INVENTION

A method and apparatus for QoS management of mobile Internet services according to the present invention will be described in detail with reference to the accompanying drawings. However, the present invention is not limited to the exemplary embodiments disclosed below, but can be implemented in various forms. The exemplary embodiments are provided to ensure that this disclosure enables those of ordinary skill in the art to practice the present invention.

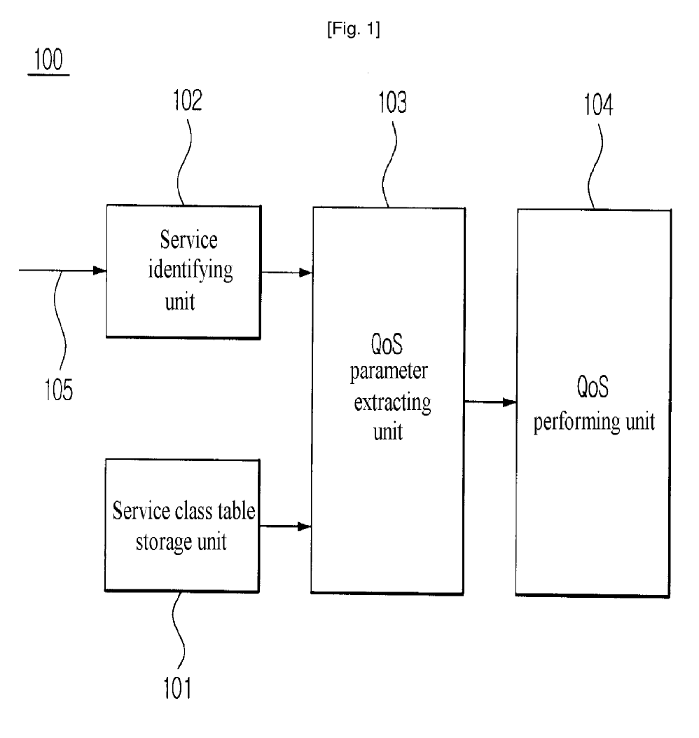

FIG. 1 is a block diagram illustrating a QoS providing system according to the present invention. Referring to FIG. 1, when a request for mobile Internet service 105 is received from a PSS, a QoS providing system 100 according to the present invention must determine an amount of network resources and a relative priority of the requested service, which are needed for providing the service. Such a determination requires traffic variables called “QoS parameter(s)”. One or more QoS parameters required for various services are pre-stored as a service class table in a service class table storage unit 101.

A service identifying unit 102 extracts QoS parameters indicating network resources required to support the requested mobile Internet service. The service identifying unit 102 then compares the extracted QoS parameters to the parameters for each service stored in the service class table to determine a service type predefined by the service class table to which the requested mobile Internet service belongs.

A QoS parameter extracting unit 103 extracts QoS parameters corresponding to the service class type identified by the service identifying unit 102 from the service class table stored in the service class table storage unit 101.

A QoS performing unit 104 performs a QoS policy corresponding to the extracted QoS parameters. The components of the QoS providing system 100 will be described in greater detail.

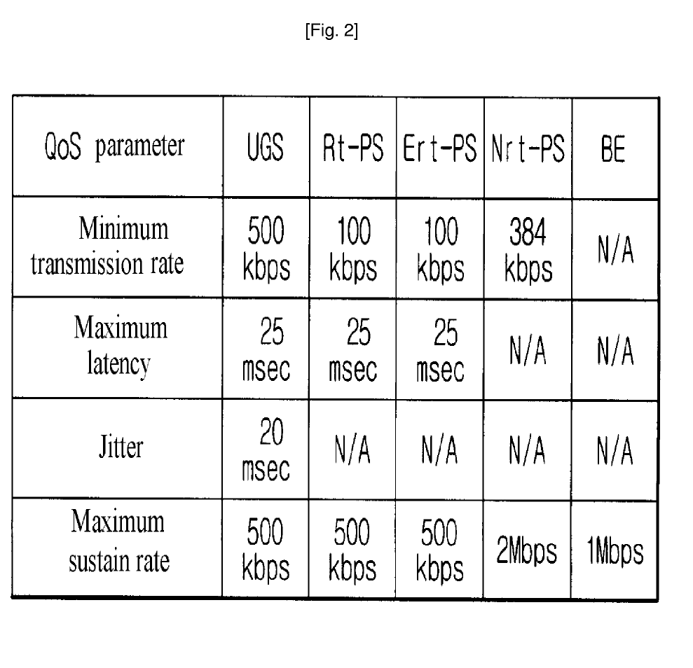

FIG. 2 shows an example of the service class table stored in the service class table storage unit 101. As shown in FIG. 2, the service class table storage unit 101 according to an exemplary embodiment of the present invention may classify a plurality of mobile Internet services into five services including unsolicited grant service (UGS), real-time polling service (Rt-PS), extended real-time polling service (Ert-PS), non-real-time polling service (Nrt-PS), and best effort (BE) service, and store QoS parameters including at least one of traffic minimum transmission rate, maximum latency, jitter, and maximum sustain rate corresponding to the services.

For the service class table of FIG. 2, if a service requiring a transmission rate of 100 kbps (e.g., movie A among broadcasting services) is requested, the service identifying unit 102 of the QoS control device according to the present invention may classify the requested service as Rt-PS or Ert-PS, create a corresponding service flow (e.g., an IP packet flow transferring movie A), and assign a wireless channel.

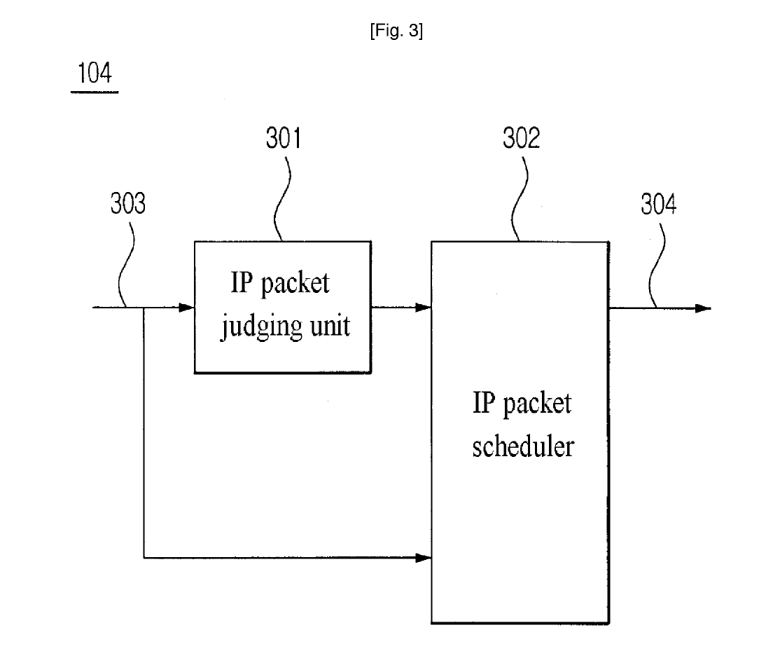

FIG. 3 is a block diagram illustrating the QoS performing unit 104 of the QoS providing system according to an exemplary embodiment of the present invention. When the QoS policy is determined by the QoS parameters required to support the requested mobile Internet service, the QoS performing unit 104 transmits Internet protocol (IP) packets received from the PSS or service provider over a mobile Internet network in a proper form and at a proper time.

Referring to FIG. 3, the QoS performing unit 104 may include an IP packet judging unit 301 for deciding a service flow to which IP packets 303 received from the PSS or service provider belongs, and an IP packet scheduler 302 for determining transmission priorities of the received IP packets 303 according to the judgment. The IP packets 304 are sent back to the service provider or PSS according to the determined priority.

According to another exemplary embodiment of the present invention, the IP packet scheduler 302 may classify a plurality of mobile Internet services into a plurality of priority groups having different priorities, and apply the same scheduling scheme to the services in the groups having the same priority.

For example, when the mobile Internet service corresponding to the received IP packet 303 is a service of a MAC management message (MNG) used for control information communication with the PSS, the IP packet scheduler 302 may perform scheduling using a fastest scheme so that the received IP packets are transmitted and received earlier than any other traffic data.

When the mobile Internet service is a best effort service, the IP packet scheduler 302 may perform scheduling by assigning the lowest priority to the received IP packets and applying a proportional fair queuing (PFQ) scheme between the IP packets corresponding to the BE service.

Finally, when IP packets corresponding to services other than the MNG service and the BE service (e.g., UGS, Rt-PS, Nrt-PS, and Ert-PS) are received, the IP packet scheduler may assign a priority lower than the MNG and higher than the BE to the received IP packets, and apply a weighted fair queuing (WFQ) scheme to packets having the same priority.

The WFQ scheme assigns a constant weight to a plurality of QoS parameters to determine priorities. The IP packet transmission priority determined by the WFQ scheme according to the present exemplary embodiment may be determined by the following equation:

[Equation 1]

P=W₁*TRₘᵢₙ+W₂*Lₘₐₓ+W₃*1/J+W₄*SRₘₐₓ+W₅*AG+W₆*QDF

Here, P denotes a relative priority for IP packet transmission, TRₘᵢₙ denotes minimum transmission rate, Lₘₐₓ denotes maximum latency, J denotes jitter, SRₘₐₓ denotes a maximum sustain rate, AG denotes an aging factor, QDF denotes a queue length factor, and W₁, W₂, W₃, W₄, W₅, and W₅ denote weights of the minimum transmission rate, the maximum latency, the jitter, the maximum sustain rate, the aging factor, and the queue length factor, respectively.

In the present exemplary embodiment, by selectively applying the different IP packet scheduling schemes according to the classes of the mobile Internet services, the QoS providing system according to the present invention can flexibly process concurrent service requests.

In another exemplary embodiment of the present invention, the QoS performing unit 104 may perform QoS only when the service requested by the PSS is not the best effort (BE) service. That is, the QoS performing unit 104 may apply the BE scheduling to services not requiring the QoS, e.g., a message data transmission service, a hyper text markup language (HTML) transmission service, and the like, as in the conventional technique, such that the services are supported by a conventional Internet network provider without an additional burden resulting from QoS implementation. In addition, for best effort service, the QoS performing unit handles it as a group independent of number of services requested. Further, since the QoS providing system according to the present invention requires receipt of the request for mobile Internet service prior to performing the QoS policy, it must handle the requested service as the BE service before performing the QoS policy. Accordingly, it is necessary to basically provide the BE service and apply a separate QoS procedure only to other services.

In the QoS providing system according to another exemplary embodiment of the present invention, the QoS performing unit determines traffic for IP packets received from the PSS by referring to the QoS parameters stored in the service class table, and may include a marker for marking or re-marking a QoS field of the IP packet according to the judgment. In this case, a QoS field of an IP packet marked in another QoS providing system relaying an IP packet may be referenced to perform QoS.

The QoS providing system according to the present invention may be disposed in a radio access station (RAS) or access control router (ACR) of a mobile Internet network.

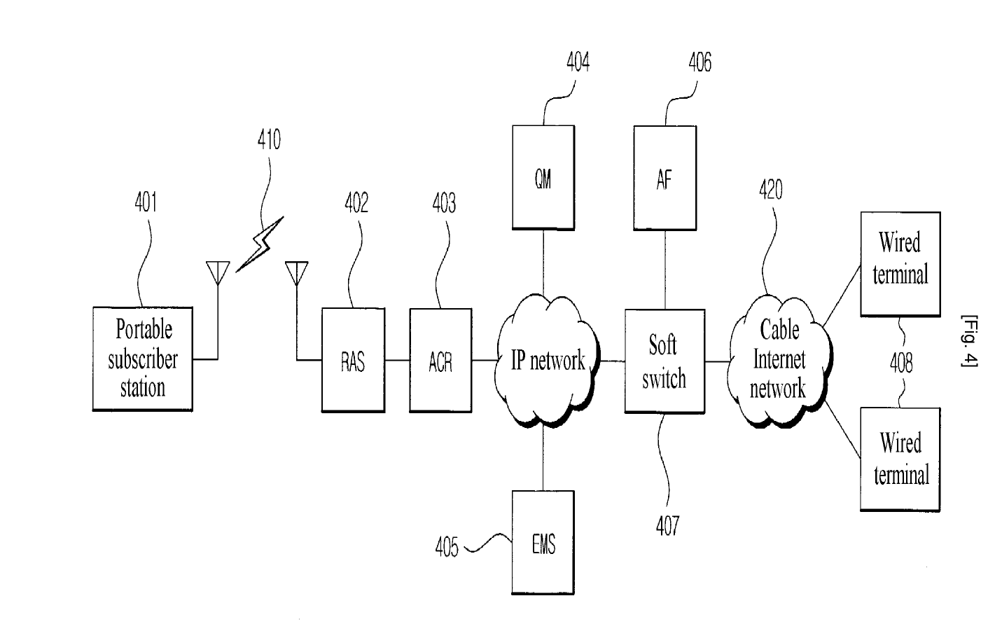

FIG. 4 is a block diagram of a mobile Internet QoS providing system according to the present invention. Referring to FIG. 4, the QoS providing system may include an element management system (EMS) 405 for creating a service class table that stores at least one QoS parameter value for each of a plurality of mobile Internet services, a quality manager (QM) 404 for generating QoS parameters indicating traffic resources required to support a requested service for mobile Internet service received from a PSS 401, an ACR 403 for comparing the QoS parameters stored in the service class table to the QoS parameters generated by the quality manager to identify a class of the requested mobile Internet service, and a RAS 402 for communicating IP packets with the PSS via a wireless channel assigned for the identified mobile Internet service.

As described previously, the QoS providing system according to the present invention may be disposed in the RAS 402 or ACR 403 of the system. By disposing the QoS providing system in the RAS 402 or ACR 403, QoS management can be effectively performed over the mobile Internet network.

FIG. 4 shows a mobile Internet network that is a combination of a wireless Internet network 410 and a wireline Internet network 420. The wireless Internet network 410 shown in FIG. 4 may be implemented by, for example, a WiBro or WiMAX system based on an orthogonal frequency division multiple access (OFDMA) scheme. Further, a wireline Internet network between a wired terminal 408 and a soft switch 407 may be, for example, a public switched telephone network (PSTN).

The soft switch 407 shown in FIG. 4 serves to relay Internet access of the wired terminal 408 by connecting between the wireline Internet network 420 and the IP network. When the PSS 401 requests mobile Internet service, the soft switch receives this request and sends it to an application function (AF) 406. Upon receipt of the service request, the AF sends the request to a QM in a network to which the AF belongs, and to another network.

The QM may extract QoS parameters for satisfying the requested service and send them to the ACR according to standard protocols such as common open policy service (COPS) or Diameter. By using COPS, which is an international standard scheme to support the QoS as stated above, the QoS providing system according to the present invention can easily interwork with other systems and can be modified with minimal burden.

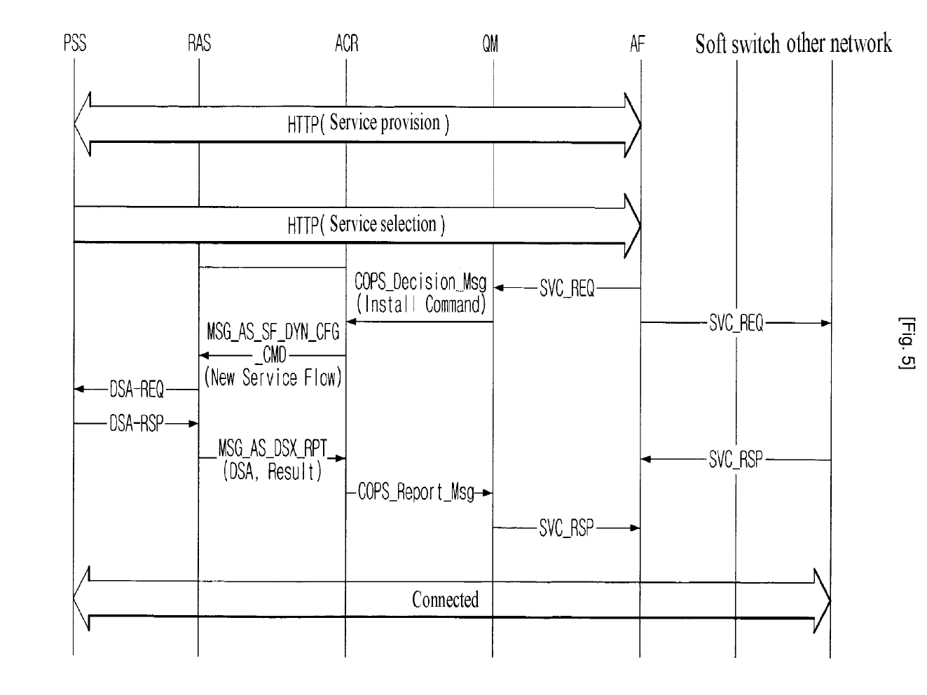

FIG. 5 shows an example of the QoS providing system according to the present exemplary embodiment, in which calls including a service request are processed by the COPS standard protocol.

A currently supported mobile Internet service is displayed on a screen of the PSS. If a user selects and requests the service, the request is sent to the AF via the RAS, the ACR, and switch. The AF requests the selected service to the QM in the WiMAX network and to another network. The QM analyzes the requested service to extract necessary QoS parameters, sends the QoS parameters to the ACR using the COPS protocol, and simultaneously requests to secure the wireless resources.

The ACR 403 determines a service flow identifier (SFID) for identifying a service flow and an IP packet classification rule according to requested matters and then sends them to the RAS 402. The RAS 402 secures wireless resources by communicating with the PSS, i.e., the PSS 401, and then sends a respond to the ACR. The ACR 403 sends this response to the QM 404. For reference, the RAS 402 can map the SFID from the ACR 403 to a connection identifier (CID) corresponding to actual wireless resources to secure the wireless resources.

The QM, in turn, sends the response to the AF 406. The AF 406 requests the same to a correspondent network providing the service and receives the response. If both responses are successful, the requested service is initiated.

According to another exemplary embodiment of the present invention, a typical differentiated service code point (DSCP), which can generally be used without further modification in the wireline network, is used for delivery of the control signal and the QoS parameters or marking/re-marking the QoS field, which make it possible to easily apply the present invention to an existing system without modification.

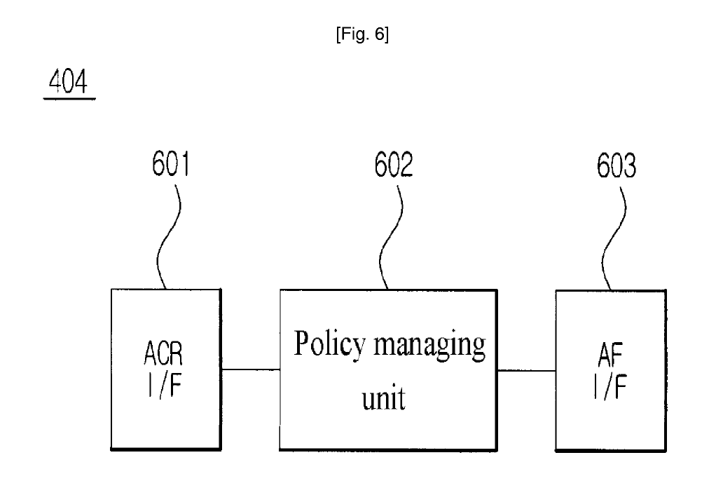

The QM 404, ACR 403, and RAS 405 for performing QoS management according to the present invention will now be described by way of example with reference to FIGS. 6 to 8.

FIG. 6 is a block diagram illustrating the QM 404 in the QoS providing system according to the present invention. The QM 404 serves to determine a QoS policy for the requested mobile Internet service and provides it to a QoS performing device.

Referring to FIG. 6, the QM may include an ACR interface 601 for communication with the ACR 403 using standard protocols, and an AF interface 603 for exchange of a service request and a service response message with the AF, as well as a policy managing unit 602 for determining QoS parameters for satisfying the service, in response to the received request for mobile Internet service.

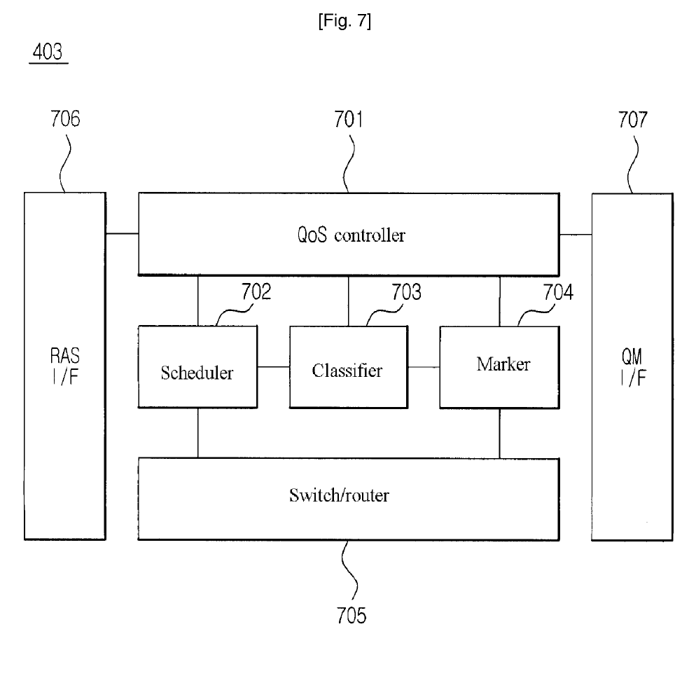

FIG. 7 is a block diagram illustrating the ACR 403 in the QoS providing system according to the present invention. The ACR 403 serves to create service flows according to a QoS policy received from the QM 404, and perform QoS policy for each created service flow. The ACR 403 sends QoS parameters received from the QM and an IP packet classification rule determined from the QoS parameters, to the RAS 402, which performs low-level QoS.

Referring to FIG. 7, the ACR may include a QoS controller 701 for confirming QoS parameters for satisfying a requested mobile Internet service by communicating with the QM when a call requiring QoS is initiated, and identifying a corresponding service type by referring to the service class table. The QoS controller can create a service flow that is an instance of the mobile Internet service according to the identified service type, manage the service flow, and send it to the RAS so that QoS management is performed for each service flow.

The ACR 403 may include a classifier 703 for classifying the received IP packets and designating a processing scheme in response to a command from the QoS controller 701, a scheduler 702 for determining a transmission priority for the received IP packet according to the command from the QoS controller 701 and the classification result from the classifier 703, and a marker 704 for marking or re-marking a QoS field of the received IP packet according to the classification result from the classifier 703 and a set command.

The ACR 403 receives the QoS parameters from the QM 404 via the QM interface 707 according to standard protocols, and sends them to the RAS 402 via the RAS interface 706. The ACR 403 includes a switch/router 705, which is a hardware device for transmitting and receiving IP packets.

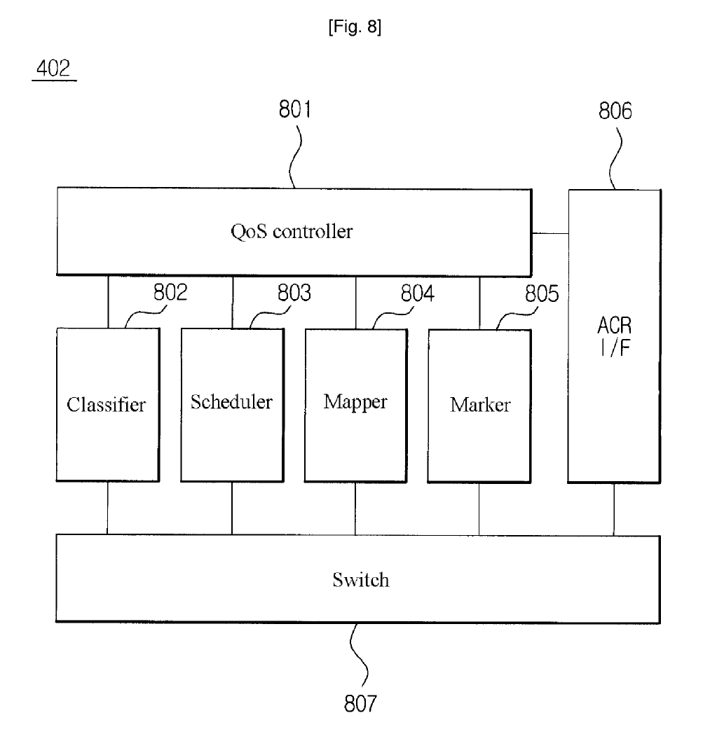

FIG. 8 is a block diagram illustrating the RAS 402 in the QoS providing system according to the present invention. The RAS is a system that performs substantial IP packet exchange for service provision with the PSS according to the QoS parameters from the QM 404 and the classification rule from the ACR 403.

Referring to FIG. 8, the RAS 402 may include a QoS controller 801, a classifier 802, a scheduler 803, a mapper 804, a marker 805, an ACR interface 806, and a switch 807.

The classifier 802, scheduler 803, marker 805, and switch 807 of the RAS 402 have the same functions or correspond to the classifier 703, scheduler 702, marker 704, and switch/router 705 of the ACR 403, and accordingly detailed description thereof will be omitted. The QoS controller 801 of the RAS 402 serves to identify a service type determined by the ACR 403 and sends a command for managing a corresponding service flow to low-level components.

The mapper 804 of the RAS 402 maps the service flow created by the ACR 403 to the actual wireless channel resources. That is, the mapper 804 identifies the service flow corresponding to the input IP packet and assigns wireless channel resources to the service flow to provide a corresponding service. For example, the mapper 804 may assign a connection identifier (CID) corresponding to the actual wireless resources to a service flow identifier (SFID) corresponding to the service flow. That is, the RAS 402 may assign the wireless resources by properly mapping the SFID of the received IP packet to the CID.

The RAS 402 may further include an ACR interface 806 for communication with the ACR 403 and the RAS 402 may include an RF transmitting and receiving module for communication with the PSS. The communication between the RAS 402 and the PSS 401 may be performed using a protocol according to the WiBro/WiMAX standard of the OFDMA scheme.

In the QoS providing system according to another exemplary embodiment of the present invention, the ACR 403 generates a service flow identifier (SFID) using the QoS parameters and the service class table, and sends the service flow identifier and at least one of the QoS parameters. After receiving the SFID and QoS parameters, the RAS 402 may assign the connection identifier (CID) according to the SFID, and provide the QoS to each SFID for a service flow other than the best effort (BE) service by considering at least one of the QoS parameters.

In this case, the CID assignment may be made by reflecting the packet classification result conforming to the IP packet classification rule created by the ACR 403 and sent to the RAS 402.

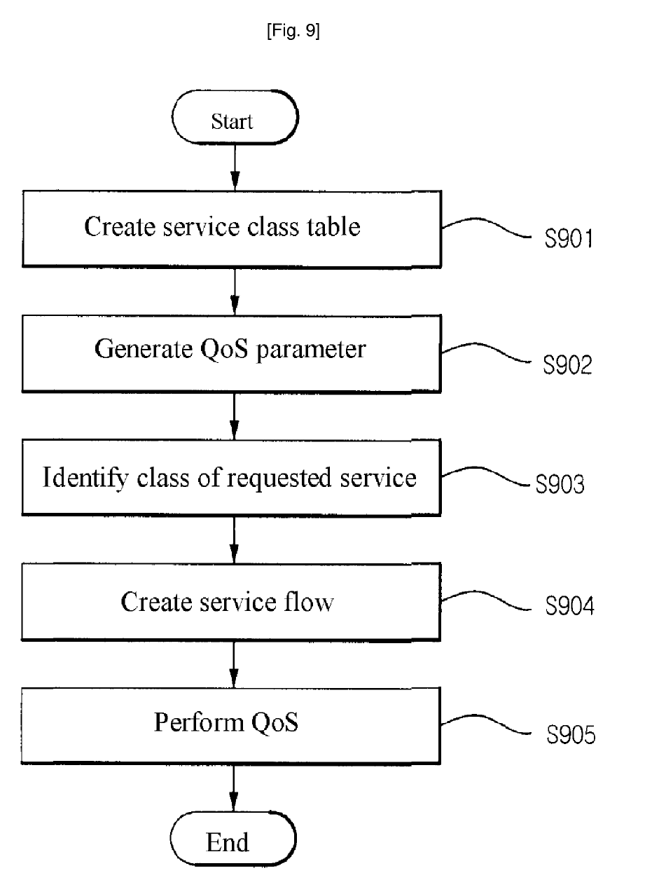

FIG. 9 is a flowchart illustrating a method for QoS management of mobile Internet services according to the present invention. Referring to FIG. 9, the QoS management method according to the present invention may include a step of creating a service class table that stores QoS parameters for mobile Internet services (S901), a step of generating QoS parameters indicating an amount of traffic resources required to provide a service in response to a request for mobile Internet service received from the PSS (S902), a step of comparing the QoS parameters stored in the service class table value to the QoS parameters generated in step S902 to identify a class of the requested mobile Internet service, a step of creating a service flow that is a service instance for QoS management according to the identified service class type (S904), and a step of performing the QoS for the requested mobile Internet service by each created service flow (S905).

The service class table created in step S901 may include at least one of QoS parameters such as a traffic minimum transmission rate, maximum latency, jitter, maximum sustain rate, and the like for each service. Step S902 may be performed by a separate device from that for step S901. The QoS parameters generated in step S902 may be the same as or included in QoS parameters generated in step S901.

Steps S903 and S904 may be performed by one device. Step S905, which performs the QoS according to an established QoS policy, may include a step of scheduling by marking/re-marking a QoS field of the input IP packet or determining transmission priorities for the input IP packets. In particular, the scheduling may be implemented by classifying the input IP packets into a plurality of corresponding groups and applying a separate scheduling scheme to each group. Further, the scheduling may be applied only to mobile Internet services other than a basic best effort service.

The method for QoS management of mobile Internet services according to an exemplary embodiment of the present invention may be performed by one device or by several devices that directly perform the QoS. When performed by several devices, the method may include a step of comparing, by the ACR 403, the QoS parameters of the service class table created by the EMS 405 to the QoS parameters created by the QM 404 to identify the class of the requested service and to create a corresponding service flow, and a step of performing, by the ACR 403 and the RAS 402, the QoS on IP packets for each service flow. That is, step S901 may be performed by the EMS 405, step S902 by the QM 404, steps S903 and S904 by the ACR 403, and step S905 by the ACR 403 and the RAS 402, in a distributive manner.

By the QoS service providing method according to another exemplary embodiment of the present invention, deciding the service class may be directly performed by the PSS. The PSS executes a specific application, and decides a class of the requested QoS service when the mobile Internet service requested by the executed application requires the QoS.

The PSS determines whether to request the QoS service to the application function according to whether the QoS service class is the best effort service. For example, when the QoS service class of the requested service is the best effort, the PSS requests to provide the service not via the AF. When the QoS service class is not the best effort, the PSS request the AF to provide the service so that proper steps for QoS provision are performed.

The QoS service class may be one of BE, UGS, Rt-PS, Ert-PS and Nrt-PS, as stated above.

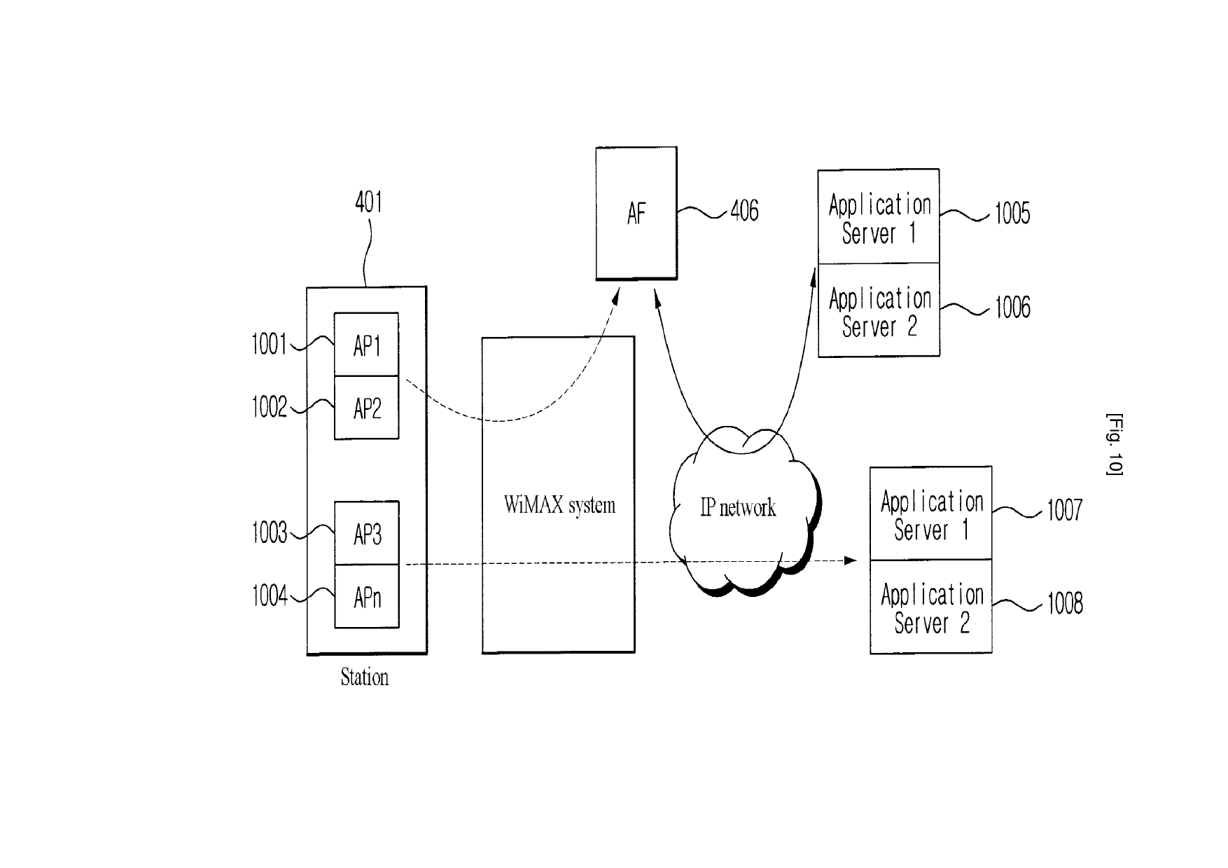

FIG. 10 shows the processes of the QoS providing method in the entire system. Referring to FIG. 10, service applications executed by the PSS 401 are classified and processed in different ways according to whether QoS is requested. The applications 1001 and 1002 requiring the QoS are connected to the application servers 1005 and 1006 via the application function (AF) 406, respectively. To this end, the service request is sent to the application transmitting unit.

On the other hand, the applications 1003 and 1004 not requiring the QoS are connected to the application servers 1007 and 1008 that will provide the service via the IP network directly, not via the AF 406.

A determination as to whether the service application executed by the PSS 401 requires the QoS is based on whether it is the best effort (BE) service. That is, if the mobile Internet service corresponding to the executed application is not the best effort service, the service request is sent to the application server via the AF 406. Whereas the mobile Internet service is the best effort service, the service request is sent to the application server via the IP network directly, not via the AF 406

According to the present exemplary embodiment, a determination as to whether to send the request for mobile Internet service to the AF 406 is directly performed by the PSS 401. The QoS is selectively applied to services other than the best effort service and not performed on the best effort service, so that it minimizes overhead due to QoS provision and effectively provides the QoS.

For reference, the “portable subscriber station (PSS)” used herein refers to hand-held wireless communication device, including a device having wireless communication functions, such as an orthogonal frequency division multiplexing (OFDM) or orthogonal frequency division multiplexing access (OFDMA) communication terminal, or a mobile terminal, such as a personal digital assistant (PDA), a hand-held PC, a notebook computer, a laptop computer, a WiBro terminal, an MP3 player, an MD player, or the like. The PSS may include a communication module, such as an OFDMA module, a Bluetooth module, an infrared data association, a wired/wireless LAN card, or a wireless communication device having a GPS chip for allowing position tracking using global positioning system (GPS). The PSS collectively refers to terminals capable of performing a computing operation using a microprocessor having a multimedia playback function to support mobile Internet service.

The method for QoS management of mobile Internet services according to the present invention may be implemented as a computer program and recorded on a computer-readable medium. The computer-readable medium may include program commands, data files, data structures or a combination thereof. Program commands recorded on the medium may be particularly designed and structured for the present invention or available to those skilled in computer programming. Examples of the computer-readable recording medium include magnetic media, such as a hard disk, a floppy disk, and a magnetic tape; optical media, such as CD-ROM and DVD; magneto-optical media, such as optical disks; ROM; RAM; and flash memory. The medium may be a transmission medium, such as an optical or metal line, a waveguide, or carrier waves transferring program commands, data structures, and the like. Program commands may be written in, for example, a high-level language code that can be executed by a computer using an interpreter, and a machine language code made by a complier. Hardware described herein may be embodied as one or more software modules to implement the present invention.

While the invention has been shown and described with reference to certain exemplary embodiments thereof, it will be understood by those skilled in the art that various changes in form and details may be made therein without departing from the spirit and scope of the invention as defined by the appended claims.

1. A QoS providing system for managing quality of mobile Internet service provided over a mobile Internet network, the system comprising:
a service class table storage unit for storing at least one QoS parameter for a plurality of mobile Internet services;
a service identifying unit for identifying a QoS service class of a mobile Internet service requested over the mobile Internet network;
a QoS parameter extracting unit for extracting a QoS parameter of the identified mobile Internet service by referring to the service class table; and
a QoS performing unit for performing QoS on the requested mobile Internet service based on the extracted QoS parameter.

2. The system according to claim 1, wherein the at least one QoS parameter is one of traffic minimum transmission rate, maximum latency, jitter, and maximum sustain rate values.

3. The system according to claim 1, wherein the QoS performing unit performs the QoS according to the QoS service class only when the requested service is not a best effort.

4. The system according to claim 1, wherein the mobile Internet network is based on an OFDMA scheme.

5. The system according to claim 1, wherein the QoS performing unit comprises:
an IP packet judging unit for identifying the mobile Internet service corresponding to IP packets received over the mobile Internet network; and
an IP packet scheduler for determining transmission priorities of the IP packets according to a predetermined scheduling scheme for the identified mobile Internet service.

6. The system according to claim 5, wherein the IP packet scheduler classifies mobile Internet services into a plurality of groups having different priorities, and applies the same scheduling scheme to services in the same priority groups.

7. The system according to claim 5, wherein the scheduling scheme includes any one of a best effort scheme, a weighted fair queuing (WFQ) scheme, and a proportional fair (PF) scheme.

8. The system according to claim 5, wherein the best effort scheduling scheme is used when the requested service is a MAC management message (MNG) service.

9. The system according to claim 5, wherein the scheduling scheme is a proportional fair queuing scheme when the requested service is a best effort service.

10. The system according to claim 5, wherein the scheduling scheme is a weighted fair queuing scheme when the requested service is a service other than an MAC management message service and a best effort service.

11. The system according to claim 10, wherein a transmission priority used in the weighted fair queuing scheme is determined by the following equation:
[Equation 2]
P=W₁*TRₘᵢₙ+W₂*Lₘₐₓ+W₃*1/J+W₄*SRₘₐₓ+W₅*AG+W₆*QDF
where, P denotes a relative priority for IP packet transmission,
TRₘᵢₙ denotes minimum transmission rate,
Lₘₐₓ denotes maximum latency,
J denotes jitter,
SRₘₐₓ denotes a maximum sustain rate,
AG denotes an aging factor,
QDF denotes a queue length factor, and
W₁, W₂, W₃, W₄, W₅, and W₅ denote weights of the minimum transmission rate, the maximum latency, the jitter, the maximum sustain rate, the aging factor, and the queue length factor, respectively.

12. The system according to claim 1, wherein the QoS performing unit comprises a marker for marking or re-marking a QoS field of IP packet according to the judgment of traffic of IP packet received over the mobile Internet network by referring to the QoS parameter stored in the service class table.

13. The system according to claim 1, wherein the QoS performing unit maps a service flow identifier to a connection identifier (CID) according to a pre- determined IP packet classification rule by referring to the service flow identifier (SFID) of the IP packet received via the mobile Internet network.

14. The system according to claim 1, wherein the QoS providing system is disposed in a radio access station (RAS) or an access control router (ACR).

15. The system according to claim 1, wherein the QoS performing unit performs the QoS for each service flow of the requested mobile Internet service.

16. A QoS providing system for managing quality of mobile Internet service provided over a mobile Internet network, the system comprising:
an element management system (EMS) for creating a service class table that stores at least one first QoS parameter for each of a plurality of mobile Internet services;
a quality manager (QM) for generating a second QoS parameter based on a request for mobile Internet service received from a portable subscriber station;
an access control router (ACR) for comparing the first QoS parameter to the second QoS parameter to identify a class of the requested mobile Internet service; and
a radio access station (RAS) for assigning a wireless channel for the identified mobile Internet service, and communicating IP packets with the PSS via the assigned wireless channel.

17. The system according to claim 16, wherein the quality manager sends the second QoS parameter to the ACR according to a common open policy service (COPS) standard protocol.

18. A QoS providing system for managing quality of mobile Internet service provided over a mobile Internet network, the system comprising:
an access control router (ACR) for generating a service flow identifier (SFID) using QoS parameters and a service class table, and transmitting the service flow identifier and at least one of the QoS parameters; and
a radio access station (RAS) for assigning a connection identifier (CID) to the SFID, and providing the QoS for a service flow other than a best effort (BE) service by considering at least one of the QoS parameters.

19. The system according to claim 18, wherein the CID is assigned by reflecting a packet classification result conforming to a predetermined IP packet classification rule.

20. The system according to claim 19, wherein the packet classification rule is created by the ACR and sent to the radio access station.

21. A QoS providing system for managing quality of mobile Internet service provided over a mobile Internet network, the system comprising:
a radio access station (RAS) for assigning a connection identifier (CID) to a service flow identifier (SFID), and providing the QoS for a service flow by considering at least one QoS parameter, wherein the radio access station comprises a scheduler for providing the QoS when the service flow does not correspond to a best effort service.

22. A QoS providing method for managing quality of mobile Internet service provided over a mobile Internet network, the method comprising the steps of:
creating a service class table storage unit for storing at least one first QoS parameter value for each of a plurality of mobile Internet services;
generating a second QoS parameter value in response to a request for mobile Internet service received from a portable subscriber station (PSS);
identifying a QoS service class of the requested mobile Internet service by comparing the first QoS parameter stored in the service class table storage unit to the second QoS parameter creating a service flow of the requested mobile Internet service according to the QoS service class; and
performing QoS on the requested mobile Internet service for each created service flow.

23. A method for providing QoS service in a terminal supporting mobile Internet services, the method comprising the steps of:
selecting a QoS service class by executing an application for a mobile Internet service; and
determining whether to request a QoS service to an application function (AF) according to whether the QoS service class corresponds to a best effort (BE) service.

24. The method according to claim 23, wherein the QoS service class includes at least one of best effort (BE) service, unsolicited grant service (UGS), real-time polling service (Rt-PS), extended real-time polling service (Ert-PS), and non-real-time polling service (Nrt-PS).

25. The method according to claim 23, wherein the step of determining whether to request a QoS service to an application function (AF) comprises the step of sending the request for QoS service not via the application function (AF) when the QoS service class is the best effort service, and sending the request for QoS service to the application function when the QoS service class is not the best effort service.

26. A computer-readable recording medium having a program recorded thereon for executing the method according to claims 22.

27. A method for providing QoS service comprising the steps of;
receiving a request of a mobile internet service;
identifying QoS parameters from the request;
creating a service flow identifier to identify a service flow based on the QoS parameters;
mapping the service flow identifier to a connection identification identifier to perform the QoS service for the service flow.

28. The method according to claim 27, wherein the QoS service is performed when the service flow identifier does not correspond to a best effort.

29. The method according to claim 27, further comprising the step of scheduling packets of the service flow based on weights of the QoS parameters.
